(19) United States
(12) Patent Application Publication
(10) Pub. No.: US 2002/0031234 A1
(43) Pub. Date: Mar. 14, 2002

(54) Microphone system for in-car audio pickup

(76) Inventors: Matthew P. Wenger, Oak Park, IL (US); Peter V. Loeppert, Hoffman Estates, IL (US); Sally L. Liu, Mt. Prospect, IL (US); Bradley F. Olson, Park Ridge, IL (US)

Correspondence Address: Wallenstein & Wagner, Ltd., 53rd Floor, 311 S. Wacker Drive, Chicago, IL, 60606-6630, US

(21) Appl. No.: 09/893,302

(22) Filed: Jun. 27, 2001

Related U.S. Application Data
(60) Provisional application No. 60/214,873, filed on Jun. 28, 2000.

(51) Int. Cl. H04B 1/00; H04R 3/00

(52) U.S. Cl. 381/86; 381/92; 381/122; 381/365

(57) ABSTRACT

A system for discerning an audible command from ambient noise in a vehicular cabin is disclosed. The system comprises a microphone array and a signal processing system.

### CROSS-REFERENCE TO RELATED APPLICATIONS:

This application claims priority from provisional application Serial No. 60/214,873 filed Jun. 28, 2000.

### FEDERALLY SPONSORED RESEARCH OR DEVELOPMENT:

Not Applicable.

### BACKGROUND OF THE INVENTION:

### Technical Field

The present invention relates to a system for discerning an audible command from ambient noise in a vehicular cabin, and more particularly, to such a system which permits audible control of vehicular functions.

Microphones located in vehicular cabins for detecting the voice of a speaker, such as of the driver and/or passengers, are well known. Typically, such microphones are for person-to-person telecommunication devices, such as cellular telephones or two-way radios.

Vehicular cabins tend to be a relatively noisy environment, including such ambient noise sources as wind noise, road noise, radio noise, fan noise, or the like. Such an environment can make accurate voice detection and recognition difficult.

The location of the speaker in a vehicular cabin also can vary, as people tend to be of different sizes, they tend to shift in their seating, and the location of a seat in a vehicle can change.

In person-to-person communication, the quality of the voice signal is not as critical, because the human ear and sound processing ability can help distinguish the voice from the noise. However, inhuman-to-machine communication, such as for voice control of vehicular functions, such voice degradation can prevent the system from operating.

The present invention is provided to solve these and other problems.

### SUMMARY OF THE INVENTION

It is an object of the invention to provide a system for discerning an audible command from ambient noise in a vehicular cabin.

In accordance with the invention, the system comprises a microphone array and a signal processing system.

It is contemplated that the microphone array is one-, two-, or three-dimensional.

It is further contemplated that the microphone array may be pivotally mounted in the vehicular cabin, such as within the vehicle's mirror. Alternatively, the microphone array may be located within the vehicle's headliner, overhead console, dashboard, visor, pillar, headrest, steering wheel, compartment door, or such other interior surface of the vehicle.

It is still further contemplated that the signal processing system may be analog, wherein the analog signal processing system performs a delay and sum processing function. Alternatively, the signal processing system may be digital, wherein the digital signal processing system performs Griffiths Jim processing, Frost processing, or adaptive signal processing, such as adaptive beamforming and/or adaptive noise reduction.

It is yet further contemplated that the system includes a plurality of microphone arrays, and the signal processing system includes multiple output channels.

It is still yet contemplated that the vehicle has a controllable parameter, and the system includes means responsive to the audible command for controlling the parameter.

It is further contemplated that the system includes means for detecting failure of one microphone of the microphone array, and means responsive to the failure detection for compensating for the failure of the microphone.

### BRIEF DESCRIPTION OF THE DRAWINGS

FIG. 1 is a block diagram of a system for discerning an audible command from ambient noise in a vehicular cabin, in accordance with the invention;

FIG. 2 is a block diagram of a second embodiment of a system for discerning an audible command from ambient noise in a vehicular cabin, in accordance with the invention; and

FIG. 3 is a perspective drawing of a vehicular cabin, illustrating locations for microphone arrays, in accordance with the invention;

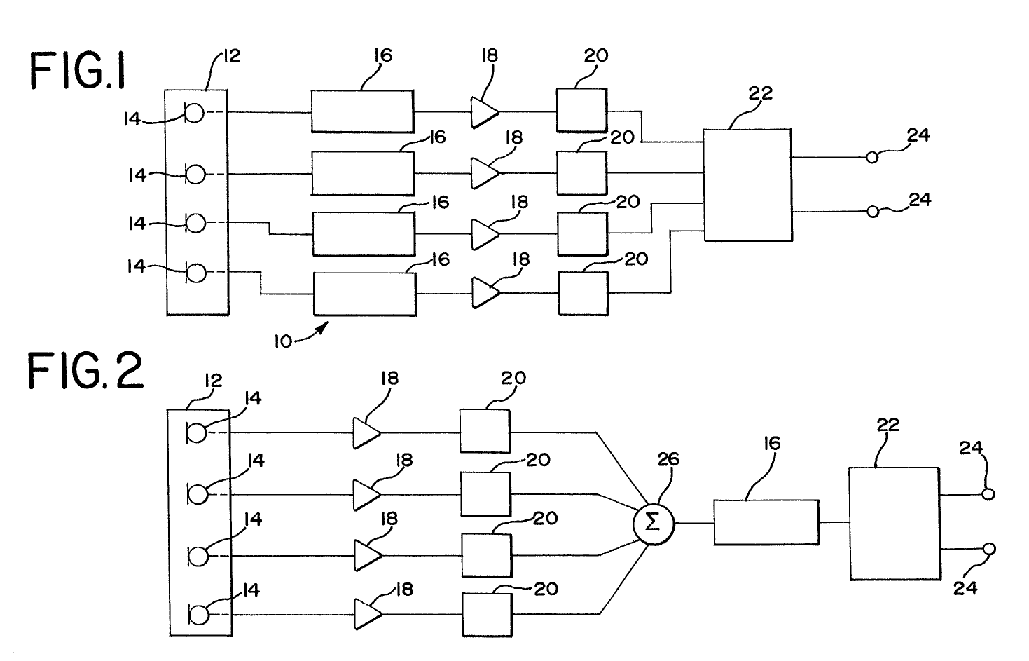

### DETAILED DESCRIPTION OF THE INVENTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

A first embodiment of a system 10 for discerning an audible command from ambient noise in a vehicular cabin, is illustrated in FIG. 1. The system includes a microphone array 12. The microphone array 12 preferably includes four microphones 14, although other quantities are possible. The microphone array 12 can be one-, two- or three-dimensional. Each of the microphones is coupled to a band-pass filter 16, which are each coupled to a respective amplifier 18. Each of the amplifiers is coupled to delay and weighting circuitry 20, which outputs are coupled to an analog or digital signal processor 22. The signal processor performs adaptive beam forming so that the microphone's pick-up pattern can be best directed at the speaker. The signal processor has one or more analog or digital outputs 24, which are coupled to such devices as a cell phone, or circuitry to control vehicular functions, such as controlling the radio, the heater/air conditioner, or the like. A more detailed explanation can be found in PCT Application WO 00/30264.

A second embodiment of a system 10′ for discerning an audible command from ambient noise in a vehicular cabin, is illustrated in FIG. 1. Like components have been given the same reference numbers as in the embodiment of FIG. 1. In the system 10′, each of the microphones 14 of the microphone array 12 is coupled to a respective one of the amplifiers 18, which is each coupled to a respective one of the delay and weighting circuitry 20. The outputs of the delay and weighting circuitry 20 are summed by a summer 26. The output of the summer 26 is coupled to the bandpass filter 16, which is coupled to an analog or digital signal processor 22. As with the first embodiment, the signal processor 22 has one or more analog or digital outputs 24, which are coupled to such devices as a cell phone, or circuitry to control vehicular functions, such as controlling the radio, the heater/air conditioner, or the like.

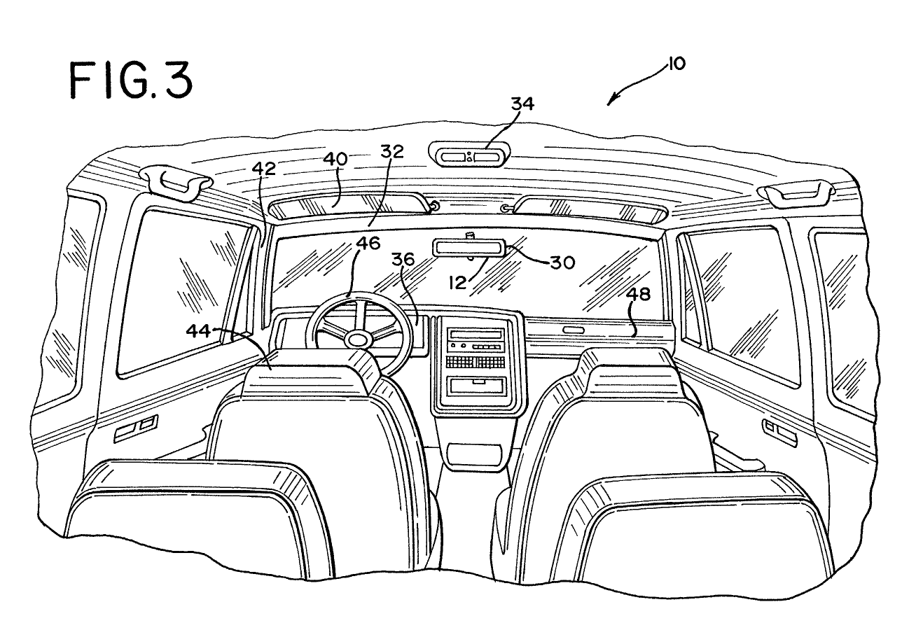

Referring to FIG. 3, the microphone array 12 can be pivotally mounted in the vehicular cabin, to better aim the pick-up pattern at the speaker. Preferably, the vehicular cabin includes a rearview mirror 30, and the microphone array 12 is located within the mirror 30. By placing the microphone array 12 in the mirror 30, the direction of the microphone array 12 will be adjusted relative to the position of the driver. A potentiometer, or other position sensor, can be attached to the mirror 30, such that the position of the mirror 30 can be detected. This positional information can be used by the signal processor 22 for further adjustment of the beam of the microphone array 12.

Other locations for the microphone array 12 are also possible. For example, the vehicular cabin includes a headliner 32, and the microphone array 12 can be located within the headliner 32. The vehicular cabin may also include a overhead console 34, and the microphone array 12 can be located within the overhead console 34. The vehicular cabin includes a dashboard 36, and the microphone array 12 can be located within the dashboard 36. The vehicular cabin also includes a visor 40, and the microphone array 12 can be located within the visor 40. The vehicular cabin includes also a pillar 42, and the microphone array 12 can be located within the pillar 12. Other possible locations include a headrest 44, a steering wheel 46, or a compartment door 48.

The signal processor 22 can perform various signal processing techniques, such as Griffiths Jim processing, Frost processing, or adaptive signal processing. It can also perform adaptive noise reduction. The signal processing may also be acoustic. The signal processor 22 includes circuitry for detecting failure of one of the microphones 14 of the microphone array 12, and circuitry responsive to the failure detection for compensating for the failure of the microphone 14. The signal processor 22 is selectively directional between two potential audible command sources.

While the specific embodiments have been illustrated and described, numerous modifications come to mind without significantly departing from the spirit of the invention and the scope of protection is only limited by the scope of the accompanying Claims.

We claim:

1. A system for discerning an audible command from ambient noise in a vehicular cabin, the system comprising:
a microphone array; and
a signal processing system.

2. The system of claim 1, wherein the microphone array is one-dimensional.

3. The system of claim 1, wherein the microphone array is two-dimensional.

4. The system of claim 1, wherein the microphone array is three-dimensional.

5. The system of claim 1, wherein the microphone array is pivotally mounted in the vehicular cabin.

6. The system of claim 1, wherein the vehicular cabin includes a rearview mirror, and the microphone array is located within the mirror.

7. The system of claim 6, including means for determining the position of the mirror.

8. The system of claim 7, wherein the position determining means comprises a potentiometer.

9. The system of claim 1, wherein the vehicular cabin includes a headliner, and the microphone array is located within the headliner.

10. The system of claim 1, wherein the vehicular cabin includes a overhead console, and the microphone array is located within the overhead console.

11. The system of claim 1, wherein the vehicular cabin includes an interior surface, and the microphone array is located within the interior surface.

12. The system of claim 1, wherein the vehicular cabin includes a dashboard, and the microphone array is located within the dashboard.

13. The system of claim 1, wherein the vehicular cabin includes a visor, and the microphone array is located within the visor.

14. The system of claim 1, wherein the vehicular cabin includes a pillar, and the microphone array is located within the pillar.

15. The system of claim 1, wherein the vehicular cabin includes a headrest, and the microphone array is located within the headrest.

16. The system of claim 1, wherein the vehicular cabin includes a steering wheel, and the microphone array is located within the steering wheel.

17. The system of claim 1, wherein the vehicular cabin includes a compartment door, and the microphone array is located within the compartment door.

18. The system of claim 1, wherein the signal processing system is analog.

19. The system of claim 18, wherein the analog signal processing system performs a delay and sum processing function.

20. The system of claim 18, wherein the analog signal processing system performs a filter and sum processing function.

21. The system of claim 1, wherein the signal processing system is digital.

22. The system of claim 21, wherein the digital signal processing system performs Griffiths Jim processing.

23. The system of claim 21, wherein the digital signal processing system performs Frost processing.

24. The system of claim 21, wherein the digital signal processing system performs adaptive signal processing.

25. The system of claim 21, wherein the digital signal processing system performs adaptive beamforming.

26. The system of claim 25, wherein the digital signal processing system performs adaptive noise reduction.

27. The system of claim 1, wherein the signal processing system is acoustic.

28. The system of claim 27, wherein the acoustic signal processing system includes a delay line.

29. The system of claim 27, wherein the acoustic signal processing system is shotgun.

30. The system of claim 1, including a plurality of microphone arrays.

31. The system of claim 1, wherein the signal processing system includes multiple output channels.

32. The system of claim 1, wherein the microphone array is directional.

33. The system of claim 32, wherein the direction of the directional microphone array is adjustable.

34. The system of claim 32, wherein the direction of the directional microphone array is electronically adjustable.

35. The system of claim 34, including means for maximizing the directionality of the directional microphone relative to the audible command.

36. The system of claim 32, wherein the direction of the directional microphone array is mechanically adjustable.

37. The system of claim 1, wherein the microphone array includes silicon based microphones.

38. The system of claim 1, wherein the vehicle has a controllable parameter, and the system includes means responsive to the audible command for controlling the parameter.

39. The system of claim 1, wherein the vehicle has a plurality of controllable parameters, and the system includes means responsive to the audible command for controlling a desired one of the parameters.

40. The system of claim 1, including means for detecting failure of one microphone of the microphone array.

41. The system of claim 40, including means responsive to the failure detection for compensating for the failure of the microphone.

42. The system of claim 1, wherein the microphone array is selectively directional between two potential audible command sources.

43. The system of claim 1, including means responsive to the audible command for controlling a vehicular function.

44. A system for discerning an audible command of a speaker from ambient noise in a vehicular cabin, the system comprising:
a microphone array having an output; and
a signal processing system coupled to the output of the array for forming a microphone beam.

45. The system of claim 44, wherein the signal processing system includes means for adaptively adjusting the microphone beam.

46. The system of claim 45, wherein the signal processing system includes means for locating the speaker.

47. The system of claim 46, wherein the signal processing system includes means for defining an acceptance area about the located speaker.

48. The system of claim 47, wherein the signal processing system includes means for adjusting the acceptance area.

49. A system for discerning an audible command of each of two speakers from ambient noise in a vehicular cabin, the system comprising:
a microphone array having an output; and
a signal processing system coupled to the output of the array for forming two microphone beams, one associated with each of the speakers.

50. The system of claim 49, wherein the signal processing system has two outputs, one associated with each of the formed beams.

51. The system of claim 49, wherein the signal processing system includes means for locating each of the speakers.

52. The system of claim 51, wherein the signal processing system includes means for defining an acceptance area about each of the located speakers.

53. The system of claim 52, wherein the signal processing system includes means for adjusting each of the acceptance areas.

54. The system of claim 49, including means for toggling between each of the beams.

55. The system of claim 49, including means responsive to the audible command for controlling a vehicular function.

56. A system for controlling a vehicular function in response to an audible command, the system comprising:
a microphone array disposed within a rear-view mirror, the rear-view mirror being disposed within a vehicular cabin;
a signal processing system coupled to the microphone array for discerning the audible command from ambient noise in the vehicular cabin; and
means responsive to the audible command for controlling the vehicular function.

57. The system of claim 56, including means for locating the speaker.

58. The system of claim 57, wherein the signal processing system includes means for defining an acceptance area about the located speaker.

59. The system of claim 57, wherein the signal processing system includes means for adjusting the acceptance area.

60. A system for controlling a vehicular function in response to an audible command, the system comprising:
a microphone array disposed within a headliner, the headliner being disposed within a vehicular cabin;
a signal processing system coupled to the microphone array for discerning the audible command from ambient noise in the vehicular cabin; and
means responsive to the audible command for controlling the vehicular function.

61. The system of claim 60, including means for locating the speaker.

62. The system of claim 61, wherein the signal processing system includes means for defining an acceptance area about the located speaker.

63. The system of claim 62, wherein the signal processing system includes means for adjusting the acceptance area.

64. A system for discerning an audible command from ambient noise in a vehicular cabin, the system comprising:
a plurality of microphone arrays; and
a signal processing system coupled to the arrays for forming a microphone beam.

65. The system of claim 64, wherein the signal processing system includes means for adaptively adjusting the microphone beam.

66. The system of claim 65, wherein the signal processing system includes means for locating the speaker.

67. The system of claim 66, wherein the signal processing system includes means for defining an acceptance area about the located speaker.

68. The system of claim 67, wherein the signal processing system includes means for adjusting the acceptance area.
